(19) United States
(12) Patent Application Publication
(10) Pub. No.: US 2026/0258886 A1
(43) Pub. Date: Sep. 3, 2026

(54) CENTRALISERS FOR PIPELINE ASSEMBLIES

(71) Applicant: ACERGY FRANCE SAS, Suresnes (FR)

(72) Inventor: Julien VERDEIL, Suresnes (FR)

(21) Appl. No.: 19/163,192

(22) PCT Filed: Mar. 7, 2024
(86) PCT No.: PCT/IB2024/000100

§ 371 Date: Sep. 8, 2025

(30) Foreign Application Priority Data
Mar. 9, 2023 (JP) 2303491.1

(51) Int. Cl. F16L 9/19; B29C 48/00; B29C 48/12; B29C 48/28; B29K 71/00

(52) U.S. Cl. CPC F16L 9/20; B29C 48/0022; B29C 48/12; B29C 48/28; B29K 2071/00

(57) ABSTRACT

Centralisers for pipe-in-pipe systems or for pipeline bundles are manufactured by forming an extrusion with a cross-sectional profile whose features extend parallel to each other and to a common extrusion direction. After optionally storing the extrusion, cuts are made across the extrusion to form a plurality of centralisers. Each centraliser is elongate in the cutting direction and shares the cross-sectional profile of the extrusion. The centraliser can be bent along its length about an axis parallel to the extrusion direction to wrap the centraliser around an inner pipe of the system or of the pipeline bundle. Before being surrounded by an outer pipe, the centraliser is secured to the inner pipe by inter-engagement of complementary fastening formations integrally formed at its opposed ends.

This invention relates to assembly of pipe-in-pipe (PiP) systems and of pipeline bundles that are suitable for use in subsea oil and gas installations.

In subsea oil and gas production, hot multi-phase production fluid comprising crude oil and/or natural gas flows along underwater pipelines. The pipelines comprise flowlines that extend across the seabed from wellheads or from other subsea structures and include risers that convey the production fluid to the surface.

To reduce heat loss from the production fluid to the much colder surrounding seawater, flowlines may be coated with thermal insulation, heated, shrouded by an external carrier pipe and/or defined by the inner pipe of a PiP system. Otherwise, thermal conduction from the flowline to the seawater could cause precipitation of a solid plug of wax, asphaltene or gas hydrate from the production fluid.

PiP systems position an inner pipe within an outer pipe to leave an insulating annulus between them. Similarly, in pipeline bundles, various pipes and other elongate elements may be positioned within and spaced from a surrounding carrier pipe.

The inner and outer pipes of a PiP system must be held spaced apart to maintain the intermediate annulus. For this purpose, spacing supports are placed between the inner and outer pipes at longitudinal intervals. Conventionally, and especially in shorter sections of PiP such as single or double pipe joints, those supports are a series of annular centralisers. Centralisers are also known in the art as spacers.

In subsea applications especially, it is important to reduce heat transfer between the inner and outer pipes of a PiP system. Thus, a layer of thermally insulating material is usually placed in the annular spaces between successive centralisers. For the same purpose, a partial vacuum may be drawn down in the annulus, which may also be filled with a thermally insulating gas.

Centralisers hold the inner pipe in concentric relation to the outer pipe, transfer loads between the inner and outer pipes and protect any insulating material in the annulus from being crushed during fabrication, installation and operation. Centralisers should also resist thermal conduction through their radial thickness, and so are commonly made of a polymer material.

Centralisers are also known for holding one or more inner elements of a pipeline bundle within a surrounding carrier pipe, and may be used to ease telescopic insertion of those elements into the carrier pipe.

Conventionally, two or more part-circumferential components pre-formed of a moulded polymer are assembled and fastened together around an inner pipe, for example by bolts, to form an annular centraliser. An example of such a centraliser is disclosed in GB 2531601.

Most commonly, the components of an annular centraliser are injection-moulded and so are dimensioned to suit a specific application, with their thickness and radius of curvature fixed and determined by the dies that are used to mould them. Consequently, differently-dimensioned inner and outer pipes necessitate different mould tools and if it is desired to modify the dimensions of centralisers along a pipeline, even if only slightly, different mould tools will be needed to mould them. This is inefficient, inflexible and very expensive.

Continuous, helically wound spacers or centralisers are also well known. For example, JP 2008062533, U.S. Pat. No. 4,570,678, GB 2196163 and GB 2602161 teach extruding helical centralisers around an inner pipeline. Extrusion allows the characteristics of the centraliser, such as its dimensions or material properties, to be modified as may be required along the length of a pipeline. Helical centralisers are also attractive for longer sections of PiP because it is generally quicker to wind them around a given length of inner pipe than to place multiple discrete centralisers along an equivalent length of inner pipe.

US 2020/191317 discloses extruded clamshell pieces of aerogel insulation for a PiP system, each piece being shaped as an arc or as half of a hollow cylinder. Two such clamshell pieces may be joined integrally by a live hinge as a single unit. However, aerogel insulation is fragile and requires the additional protection of centralisers to maintain an annular gap between inner and outer pipes.

U.S. Pat. No. 3,374,308 describes an insulating spacer formed from multiple segments that attach to one another via complementary tongue and groove features to form an annular collar around a conduit.

U.S. Pat. No. 5,069,255 describes a pipeline casing insulator for supporting a coated pipe within a tubular metallic casing. The insulator comprises a flexible belt. A plurality of parallel bar-like runners are formed from a polymer concrete that is cast onto an outer surface of the belt.

JP 2022063590 describes a spacer for use between inner and outer pipes. The spacer comprises a pair of bodies which in combination form an annular collar.

It is against this background that the present invention has been devised.

From one aspect, the invention resides in a method of manufacturing centralisers for pipe-in-pipe systems or for pipeline bundles. That method comprises: forming an extrusion with a cross-sectional profile such that features of the profile extend parallel to an extrusion direction; and cutting the extrusion in a cutting direction substantially orthogonal to the extrusion direction to form a plurality of centralisers, each of those centralisers being elongate in the cutting direction and having the cross-sectional profile of the extrusion.

The method may further comprise an intermediate step of storing the extrusion in a curved configuration before cutting the extrusion. The extrusion can also be transported conveniently from an extrusion facility to a pipeline manufacturing facility when stored in the curved configuration. For example, the extrusion could be stored in a coiled configuration or in a spiral configuration, being bent into either of those curved configurations about an axis that is substantially orthogonal to the extrusion direction or, therefore, parallel to the eventual cutting direction.

Whilst the extrusion may be formed in a substantially planar configuration, each centraliser cut from the extrusion can then be bent about an axis parallel to the extrusion direction. For example, the centraliser can be plastically deformed about a curved mandrel and/or wrapped around an inner pipe before being secured to the inner pipe.

Thus, the inventive concept can also be expressed as a method of centralising an inner pipe within a pipe-in-pipe system or a pipeline bundle, that method comprising: providing at least one elongate centraliser having cross-sectional profile features extending parallel to each other in a common direction being an extrusion direction where such a profile is extruded; bending the or each centraliser along its length about an axis substantially parallel to the common direction; wrapping the or each centraliser around the inner pipe, for example progressively in a circumferential direction; and securing the or each centraliser to the inner pipe. Preferably, the or each centraliser is wrapped circumferentially around the inner pipe in a plane orthogonal to a longitudinal axis of the inner pipe. The or each centraliser may comprise an extruded body.

The or each centraliser can be secured to the inner pipe by coupling opposed ends of the or each centraliser to each other. Conveniently, the opposed ends can be coupled by inter-engaging complementary fastening formations of the respective ends, those formations being among the cross-sectional profile features of the or each centraliser. Inter-engagement can be achieved by a resilient snap-fit action or by effecting relative sliding movement between the formations in directions parallel to the common direction.

Shortening of the or each centraliser along a bend intrados can be accommodated by narrowing cut-out formations on a corresponding face of the or each centraliser, those formations being among its cross-sectional profile features.

The inventive concept can also be expressed as a centraliser for a pipe-in-pipe system or for a pipeline bundle, the centraliser comprising an elongate and suitably extruded body of a pliant polymer with cross-sectional profile features that extend parallel to each other in a common direction transverse to a direction of elongation of the body.

The cross-sectional profile features may include: a series of cut-out formations distributed along a length of the body and recessed into a face of the body that lies parallel to the common direction; a plurality of voids within and distributed along a length of the body, those voids extending between and opening onto faces of the body that are transverse to the common direction; and/or inter-engageable complementary fastening formations at respective opposed ends of the centraliser. As noted above, such fastening formations may be inter-engageable by a snap-fit action or by relative sliding movement.

The inventive concept also embraces a pipe-in-pipe system or a pipeline bundle comprising at least one centraliser of the invention disposed between inner and outer pipes of the system or of the bundle.

The invention seeks to enable annular centralisers to benefit from the versatility of extruded helical centralisers by pursue a beneficial trade-off between the different prior art approaches discussed above. Thus, the invention provides a multi-purpose extruded annular centraliser.

Embodiments of the invention implement a method to manufacture centralisers for pipe-in-pipe arrangements, the method comprising: determining the thickness of at least one centraliser; extruding a section of pliant polymer with said thickness; and cutting at least one centraliser from the extruded section of pliant polymer, optionally after storing a coil or spiral of the extruded section. The pliant polymer may comprise any suitable extrudable thermoplastic or thermoset material, for example PEEK (polyether ether ketone).

The method may also comprise wrapping and securing the at least one centraliser around the inner pipe. For this purpose, the extruded section of pliant polymer may have a corrugated profile to allow wrapping around the inner pipe.

The method may comprise varying the thickness of the extruded section, for example to comply with a variable thickness requirement along the pipeline.

The extruded section may have formations to accommodate and to locate elongate elements such as heating elements that will be extend along the annulus of a PiP system. Such formations may be provided on what will become a radially inner side of the centraliser in use.

The extruded section may comprise internal channels that define internal voids penetrating the centraliser from one cut face to another cut face.

In summary, centralisers for pipe-in-pipe systems or for pipeline bundles may be manufactured in accordance with the invention by forming an extrusion with a cross-sectional profile whose features extend parallel to each other and to a common extrusion direction. After optionally storing the extrusion, cuts are made across the extrusion to form a plurality of centralisers. Each centraliser is elongate in the cutting direction and shares the cross-sectional profile of the extrusion.

Each centraliser can be bent along its length about an axis parallel to the extrusion direction to wrap the centraliser around an inner pipe of the system or of the bundle.

Before being surrounded by an outer pipe, each centraliser may be secured to the inner pipe by inter-engagement of complementary fastening formations integrally formed at its opposed ends.

In order that the invention may be more readily understood, reference will now be made, by way of example, to the accompanying drawings in which:

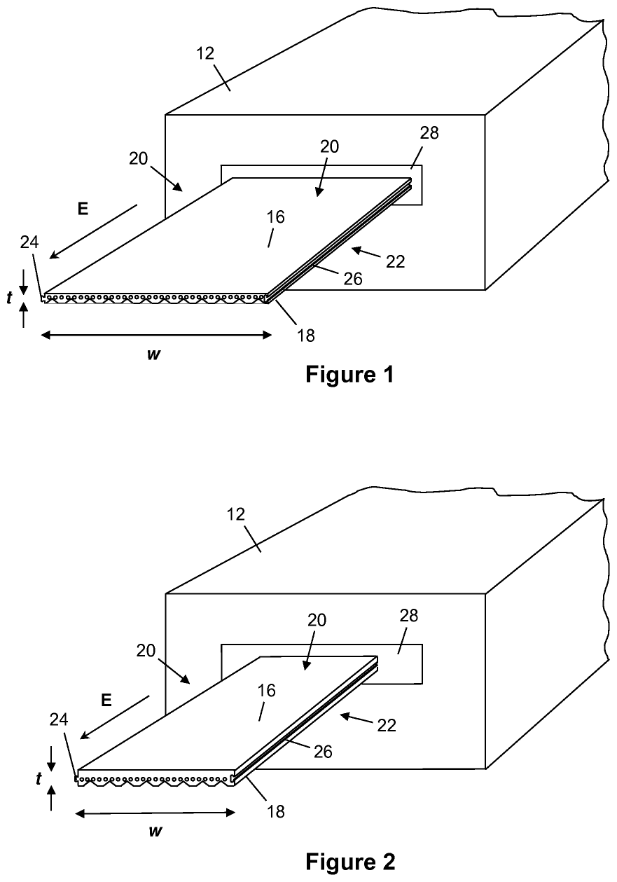

FIG. 1 is a schematic perspective view of a centraliser extrusion of the invention while being formed by an extruder;

FIG. 2 corresponds to FIG. 1 but shows a die of the extruder replaced or adjusted to produce a centraliser extrusion with a cross-sectional profile of different shape and/or dimensions;

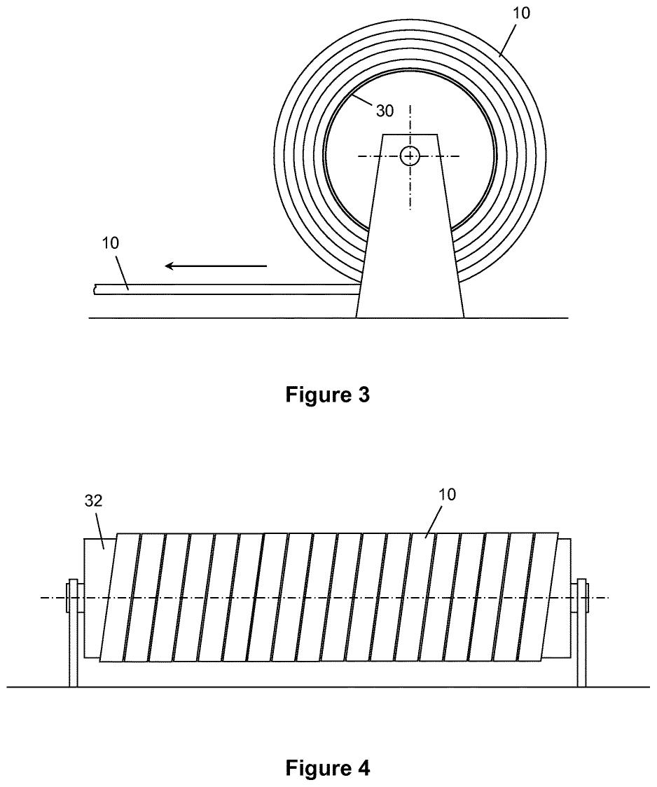

FIG. 3 is a schematic side view of a reel storing a centraliser extrusion of the invention in a coiled configuration;

FIG. 4 is a schematic side view of a drum storing a centraliser extrusion of the invention in a spiral configuration;

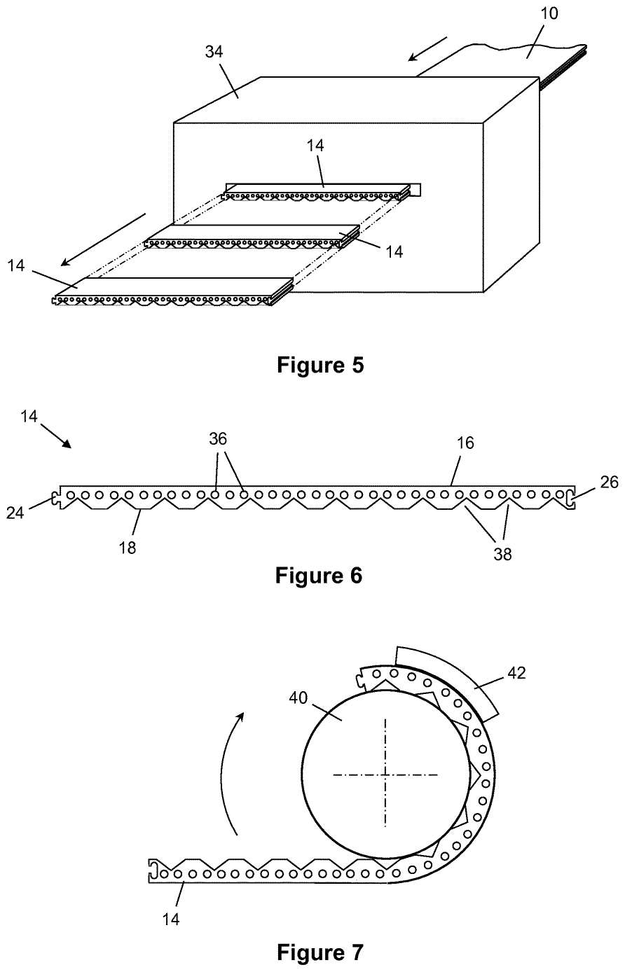

FIG. 5 is a schematic perspective view of a centraliser extrusion of the invention being cut transversely to produce multiple individual centralisers each with the profile of the extrusion;

FIG. 6 is a schematic end view of a centraliser of the invention cut from the centraliser extrusion as shown in FIG. 5;

FIG. 7 is a schematic end view of the centraliser of FIG. 6 being bent along its length around a former;

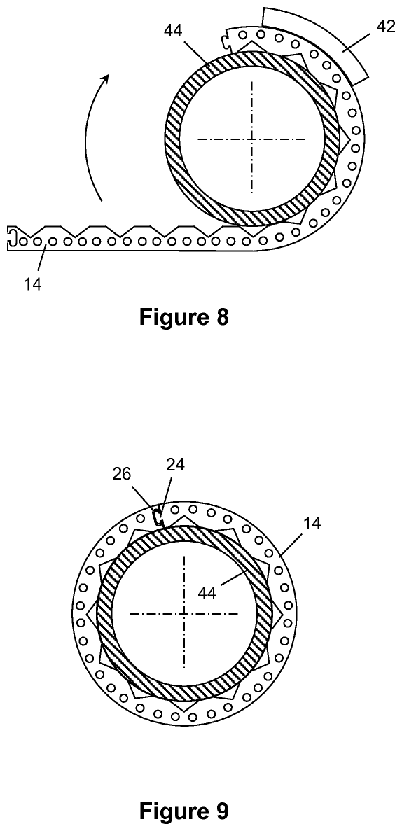

FIG. 8 is a schematic end view of the centraliser of FIG. 6 being bent along its length around an inner pipe of a PiP system;

FIG. 9 corresponds to FIG. 8 but shows the centraliser now fastened around the inner pipe;

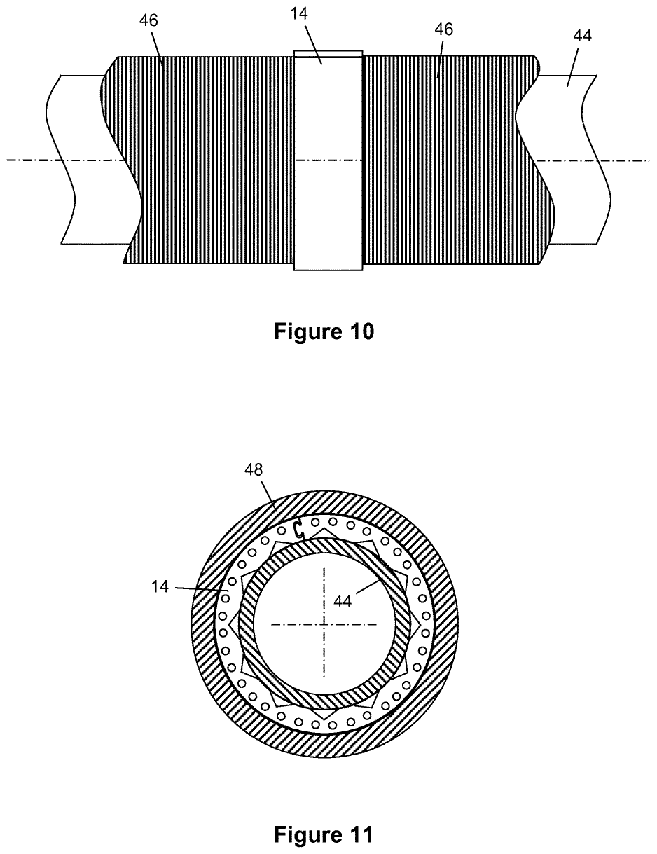

FIG. 10 is a schematic side view of the centraliser fastened around the inner pipe as shown in FIG. 9; and

FIG. 11 is a schematic end view of the centraliser and inner pipe of FIG. 9 inserted into an outer pipe of the PiP system.

Referring firstly to FIGS. 1 and 2, these drawings show a centraliser extrusion 10 of indeterminate length being produced by an extruder 12. The extrusion 10 advances from the extruder 12 in an extrusion direction E, and is shaped with a cross-sectional profile that includes internal and external features all extending in that longitudinal direction E. The features of the profile will be described in more detail below with reference to FIG. 6 of the drawings, which shows a centraliser 14 cut from the extrusion 10 of FIG. 1.

The extrusion 10 is formed of a thermoplastic polymer such as PEEK that retains pliancy when set or cured but has sufficient stiffness and strength to sustain compressive loads of, for example, 500 kN in use.

The extrusion 10 has opposed major faces 16, 18 spaced apart by the thickness t of the extrusion 10 and opposed side edges 20, 22 spaced apart by the width w of the extrusion 10. The thickness t and the width w are expressed in respective directions that are orthogonal to the extrusion direction E and to each other.

In these examples, the extrusion 10 is substantially planar across its width w although it could instead be curved across its width w to approach the curvature of a pipe that the centraliser 14 will surround. The face 16 shown here on the upper side of the extrusion 10 corresponds to a radially outward side of the centraliser 14 when in use, and is relatively plain. The other face 18 shown here on the lower side of the extrusion 10 corresponds to a radially inward side of the centraliser 14 when in use, and is more heavily contoured as will be explained.

The side edges 20, 22 of the extrusion 10 are shaped to define complementary fastening formations, exemplified here by an elongate tongue 24 extending along one of the side edges 20 that can be received in a complementary groove 26 extending along the other side edge 20. The tongue 24 and the groove 26 can engage with each other as a snap fit or as a sliding fit.

The extruder 12 comprises a die 28 that is shaped to impart desired profile features to the extrusion 10. The die 28 may be interchangeable or adjustable to produce an extrusion 10 with any desired profile, even during a pipeline manufacturing operation in which the centralisers 14 are used. For example, a comparison between FIGS. 1 and 2 shows that the thickness t of the extrusion 10 of FIG. 2 is greater whereas its width w is less than the corresponding dimensions t and w of the extrusion 10 of FIG. 1.

The extrusion 10 can be cut into multiple centralisers 14 immediately downstream of the extruder 12. Alternatively, a substantial length of the extrusion 10 can be held in an intermediate store or cache before being cut, and could be transported from an extrusion facility to a pipeline fabrication facility before being cut. In this respect, FIGS. 3 and 4 show intermediate storage configurations in which the strip-like extrusion 10 is held curved along its length. Specifically, FIG. 3 shows the extrusion 10 spooled in radially-successive coils on a reel 30, whereas FIG. 4 shows the extrusion 10 wound on a drum 32 in longitudinally-successive spiral loops. In principle, more than one layer of such loops of the extrusion 10 could be wound onto the drum 32.

Turning next to FIG. 5, this shows a cutter 34 receiving the extrusion 10 either directly from the extruder 12 shown in FIGS. 1 and 2 or from an intermediate store such as the reel 30 of FIG. 3 or the drum 32 of FIG. 4. Within the cutter 34, a blade slices the extrusion 10 widthways in a direction orthogonal to the extrusion direction E, hence producing a series of centralisers 14 shown here emerging separately from the cutter 30.

The centralisers 14 are elongate in the widthwise direction of the extrusion 10. Thus, the length of each centraliser 14 corresponds to the width w of the extrusion 10 as shown in FIGS. 1 and 2, and the ends of the centraliser 14 correspond to the side edges 20, 22 of the extrusion 10. Thus, the aforementioned tongue 24 and groove 26 extend across respective ends of the centraliser 14.

The width of each centraliser 14 extending in a direction corresponding to the extrusion direction E shown in FIGS. 1 and 2 can be varied, for example from 10 mm to 40 mm or more. The side faces of each centraliser 14, being the cut faces defined by the slicing blade of the cutter 30, are mutually parallel.

The extruded profile of one of the centralisers 14 is shown in more detail in FIG. 6. This shows that in addition to the features described previously, the profile may comprise a plurality of channels or voids 36 to improve thermal insulation by reducing conduction of heat between the major faces 16, 18. The voids 36 also reduce material usage. The voids 36 are open at their opposed ends where they are cut and therefore intersect with the side faces of the centraliser 14. In this example, the voids 36 are otherwise closed and do not communicate with the faces 16, 18 or the ends of the centraliser 14.

The face 18 corresponding to the radially inward side of the centraliser 14 in use comprises a lengthwise series of cut-outs or recesses 38 that each taper toward the opposed face 16. Thus, in end view, this series of notch-like recesses 38 confers a saw-tooth shape on the face 18 and hence confers a corrugated profile on the centraliser 14. The recesses 38 reduce the thickness of the centraliser 14 at their respective locations to ease bending the centraliser 14 along its length. Indeed, the recesses 38 could define a series of live hinges where the body of the centraliser 14 is narrowed in alignment with their successive apices.

Additionally, the recesses 38 in the face 18 distributed along the length of the centraliser 14 provide clearance for the centraliser 14 to reduce in length along the intrados of the bend, allowing the centraliser 14 to bend without buckling. Nevertheless, the full-thickness portions of the centraliser 14 between the recesses 38 maintain effective resistance to compressive forces acting between the faces 16, 18, hence in radial directions when the centraliser 14 is in use.

FIGS. 7 and 8 show the centraliser 14 being bent along its length, hence about an axis parallel to the extrusion direction E, to adopt its final full-circumferential configuration. In this process, the centraliser 14 may undergo plastic deformation. For example, FIG. 7 shows the option of pre-bending the centraliser 14 around a curved mandrel 40 when held against the mandrel by a clamping shoe 42. This imparts a set in the curvature of the centraliser 14 that could ease subsequent installation of the centraliser 14 onto a pipe. Conversely, FIG. 8 shows the centraliser 14 being wrapped around an inner pipe 44 of a PiP system while being held against the pipe by a clamping shoe 42. In each case, the necessary bending force may be applied to the free end of the centraliser 14 either manually or by a bending machine.

Eventually, as shown in FIGS. 9 and 10, the opposed ends of the centraliser 14 are brought into abutment at a mutual interface, whereupon their fastening formations are inter-engaged to hold the centraliser 14 on the pipe 44. As noted above, the tongue 24 can be received by the groove 26 as a snap fit or as a sliding fit. In the former case, the opposed ends of the centraliser 14 are simply pressed together in a circumferential direction until the tongue 24 engages with the groove 26. In the latter case, the centraliser 14 is twisted slightly into a shallow spiral to offset its opposed ends to the extent that the tongue 24 and the groove 26 can be brought into mutual axial alignment. The centraliser 14 can then be untwisted, for example by relaxation of elastic deformation, to effect relative sliding movement between the tongue 24 and the groove 26 as they engage with each other.

FIG. 10 shows one of a longitudinally-spaced series of centralisers 14 mounted on an inner pipe 44 of a PiP system. FIG. 10 also shows thermal insulation 46 wrapped around the pipe 14 in gaps between successive centralisers 14. The thermal insulation 46 will lie in the annulus between the inner pipe 44 and the outer pipe of a completed PiP system. In this respect, FIG. 11 corresponds to FIG. 9 but shows the centraliser 14 and the inner pipe 44 of FIG. 9 inserted into an outer pipe 48 of the PiP system. It will be apparent that the voids 36 and/or the recesses 38 could provide paths through the centraliser 14 for elements that extend longitudinally within the annulus, such as fibre-optic cables or heating wires.

Many other variations are possible within the inventive concept. For example, it is not essential for the profile of a centraliser to include complementary fastening formations at its ends. The opposed side edges could instead abut and be fastened together by a separate locking element such as a pin that is inserted into opposed grooves of the side edges. It would also be possible to secure a centraliser of the invention by encircling it with a circumferential strap under tension.

A centraliser of the invention could be formed from more than one extrusion joined edge-to-edge, for example with fastening formations like those described above, each of those extrusions extending around a respective sector portion of a full circumference of the centraliser.

1.-24. (canceled)

25. A method of manufacturing centralisers for pipe-in-pipe systems or for pipeline bundles, the method comprising:
forming an extrusion with a cross-sectional profile such that features of that profile extend parallel to an extrusion direction, comprising forming the extrusion in a substantially planar configuration; and
cutting the extrusion in a cutting direction substantially orthogonal to the extrusion direction to form a plurality of centralisers, each of those centralisers being elongate in the cutting direction and substantially planar across their elongate length, and having the cross-sectional profile of the extrusion.

26. The method of claim 25, further comprising an intermediate step of storing the extrusion in a curved configuration before cutting the extrusion.

27. The method of claim 26, comprising storing the extrusion in a coiled configuration.

28. The method of claim 26, comprising storing the extrusion in a spiral configuration.

29. The method of claim 26, comprising bending the extrusion about an axis that is substantially orthogonal to the extrusion direction to adopt the curved configuration.

30. The method of claim 26, comprising transporting the extrusion from an extrusion facility to a pipeline manufacturing facility when stored in the curved configuration.

31. The method of claim 25, followed by bending the or each centraliser about an axis parallel to the extrusion direction.

32. The method of claim 31, comprising plastically deforming the or each centraliser about a curved mandrel.

33. The method of claim 31, comprising wrapping at least one of the plurality of centralisers around an inner pipe and securing the or each centraliser to the inner pipe.

34. A method of centralising an inner pipe within a pipe-in-pipe system or a pipeline bundle, the method comprising:
providing at least one elongate centraliser comprising an extruded body that is substantially planar across its elongate length and that has extruded cross-sectional profile features extending parallel to each other in a common direction;
bending the or each centraliser along its elongate length about an axis substantially parallel to the common direction;
wrapping the or each centraliser around the inner pipe; and
securing the or each centraliser to the inner pipe.

35. The method of claim 34, comprising wrapping the or each centraliser around the inner pipe progressively in a circumferential direction.

36. The method of claim 34, comprising wrapping the or each centraliser circumferentially around the inner pipe in a plane orthogonal to a longitudinal axis of the inner pipe.

37. The method of claim 34, comprising securing the or each centraliser to the inner pipe by coupling opposed ends of the or each centraliser to each other.

38. The method of claim 37, comprising coupling the opposed ends of the or each centraliser by inter-engaging complementary fastening formations of the respective ends, those formations being among the cross-sectional profile features of the or each centraliser.

39. The method of claim 38, comprising inter-engaging the fastening formations by a snap-fit action.

40. The method of claim 38, comprising inter-engaging the fastening formations by effecting relative sliding movement between those formations in directions parallel to the common or extrusion direction.

41. The method of claim 34, comprising accommodating shortening of the or each centraliser along a bend intrados by narrowing of cut-out formations on a corresponding face of the or each centraliser, those formations being among the cross-sectional profile features of the or each centraliser.

42. A centraliser for a pipe-in-pipe system or for a pipeline bundle, the centraliser comprising an elongate substantially planar extruded body of a pliant polymer with cross-sectional profile features that extend parallel to each other in a common direction, wherein the cross-sectional profile features include a series of cut-out formations distributed along a length of the body and recessed into a major face of the body that lies parallel to the common direction.

43. The centraliser of claim 42, wherein the cross-sectional profile features include a plurality of voids within and distributed along a length of the body, those voids extending between and opening onto faces of the body that are transverse to the common direction.

44. The centraliser of claim 42, wherein the cross-sectional profile features include inter-engageable complementary fastening formations at respective opposed ends of the centraliser.

45. The centraliser of claim 44, wherein the fastening formations are inter-engageable by a snap-fit action.

46. The centraliser of claim 44, wherein the fastening formations are inter-engageable by relative sliding movement in directions parallel to the common direction.

47. A pipe-in-pipe system or a pipeline bundle comprising at least one centraliser of claim 42 disposed between inner and outer pipes of the system or the bundle.
